(19) United States
(12) Patent Application Publication
(10) Pub. No.: US 2014/0268315 A1
(43) Pub. Date: Sep. 18, 2014

(54) GLASS SELECTION FOR INFRARED LENS DESIGN

(71) Applicant: SCHOTT CORPORATION, Elmsford, NY (US)

(72) Inventor: Nathan CARLIE, Waverly, PA (US)

(73) Assignee: SCHOTT CORPORATION, Elmsford, NY (US)

(21) Appl. No.: 14/218,333

(22) Filed: Mar. 18, 2014

Related U.S. Application Data
(60) Provisional application No. 61/791,557, filed on Mar. 15, 2013.

(51) Int. Cl. G02B 13/14

(52) U.S. Cl. CPC G02B 13/14
USPC 359/356

(57) ABSTRACT

The invention relates to process for manufacturing infrared optical lenses that will transmit in multiple infrared bands, for example, lenses with multiple optical elements such as doublet and triplet lenses (i.e., achromatic, apochromatic, and superachromatic optical elements). The lens materials are selected on the basis of dispersion ratios and/or minimum dispersions and minimum dispersion wavelengths as defined herein.

### SUMMARY OF THE INVENTION

The invention relates to process for manufacturing infrared optical lenses that will transmit in multiple infrared bands. For example, the invention relates to the manufacture of lenses with multiple optical elements such as doublet and triplet lenses (i.e., achromatic, apochromatic, and superachromatic optical elements) using lens materials that are selected on the basis of dispersion ratios and/or minimum dispersions and minimum dispersion wavelengths as defined herein.

An achromatic lens is made by combining two different lens materials that have different dispersion properties (i.e., a positive power crown glass and a negative power flint glass). The achromatic lens functions to bring two different wavelengths both into focus on the same focal plane, thereby reducing chromatic aberration. Apochromatic lenses involve multiple materials and are designed to bring three or more wavelengths into focus in the same plane. A superachromatic lens also involves involve multiple materials and corrects for four or more wavelengths.

Infrared (IR) materials are currently being developed for the construction of achromatic, apochromatic, and superachromatic optics that cover multiple IR bands simultaneously. These bands are typically referred to as Visible-Near Infrared (Vis-NIR; i.e., 0.4-1.0 μm) Short Wavelength Infrared (SWIR; 0.9-1.7 μm), Medium Wavelength Infrared (MWIR; 3-5 μm) and Long Wavelength Infrared (LWIR; 8-12 μm). However, designing refractive optics capable of covering such a broad range of wavelengths is difficult, if not impossible, using traditional methods, which involve the use of Abbe number and partial dispersion.

The reasons for this difficulty are complex. Firstly, the value of μ (μ=n−1, where n is the refractive index) which determines the focusing power of a lens of a given curvature, can vary dramatically (as much as 30%) over the entire IR spectral range (roughly about 0.4-12.0 μm). Conversely, the value of p is normally assumed to be a constant for simplicity for traditional glasses at visible wavelengths.

Secondly, the Abbe number, V, is poorly defined in the IR portion of the spectrum. The Abbe number is an indication of a material's dispersion. For traditional glasses at visible wavelengths, a glass with a large Abbe number (such as V>50) is generally said to be a “crown” glass (generally lower refractive index, low dispersion), while a glass with a small Abbe number (such as V<50) is said to a “flint” glass (generally higher refractive index, high dispersion). Glasses with higher Abbe numbers produce less chromatic aberration than glasses with lower Abbe numbers.

However, many IR transparent materials will change roles depending on the Abbe number which is chosen to mark the boundary between crown and flint, and, more importantly, depending on the spectral range of interest. Thus, a crown/flint pair in the LWIR band may become a flint/crown pair in the SWIR band.

Similar to Abbe number is partial dispersion (P) which denotes the difference in dispersion between shorter and longer wavelengths within a particular band. Much as with Abbe number, the P value can vary in different ways when comparing materials in the various bands, causing materials to swap roles. Also, the P value covers a much larger range in the infrared bands as compared to visible glasses. For traditional visible range optical glass, P values vary from 0.5 to 0.6, while for infrared materials P values may vary from 0.2 to 1.5 depending on the wavelength range.

Finally, β is the change in refractive index with temperature (dn/dT). Large and often negative variation of refractive index with wavelength (β) can present great difficulties in design when the device is intended to operate over a wide range of temperatures. This is because a change in refractive index will result in a change in the focal length of a lens, which when combined with thermal expansion (α) can lead to a loss of focus with temperature change. Unlike visible glasses, β has a strong dependence on wavelength for IR materials, which may also be seen as a temperature dependence for both the dispersion and partial dispersion, which leads to additional complexity in balancing properties.

This invention details a novel method of defining dispersion in IR materials in order to simplify the selection of materials which will work in concert to eliminate the thermal and wavelength dependence of focal length which is caused by the above effects in single-element lenses. It is particularly important to use a consistent form of equations for calculating the relationship between refractive index and wavelength for all IR materials, as this highlights similarities in materials which are not apparent from V and P values alone. By doing so, a new set of equations can be derived which allows an optical designer to account for the spectral dependence of the values of μ, P, V, and β in order to obtain a balanced optical design which can function in multiple wavelength bands simultaneously.

The invention utilizes re-definitions of Abbe number (V) and partial dispersion (P) as the instantaneous first and second derivatives, v and ρ, respectively, of n−1 (μ). By using these terms, as well as a consistent equation to define the relationship between index and wavelength, the similarities become more apparent than the differences—which are accentuated by single values of V and P—which help make glass selection more clear. By deriving the optical power (or curvature) which should be placed in each lens of a multiple-lens assembly from the wavelength dependence of v and p, the usual variation of V and P which occurs when changing IR bands is avoided.

Thus, according to one aspect of the invention there is provided a method of manufacturing an infrared optical lens comprising a plurality of infrared optical elements, the method comprising: selecting glasses for at least two infrared optical elements such that the glasses have similar minimum dispersion wavelengths but differing values of minimum dispersion; and joining the at least two infrared optical elements together.

According to another aspect of the invention there is provided a method of manufacturing an infrared optical lens comprising a plurality of infrared optical elements, the method comprising: selecting glasses for at least two infrared optical elements such that the glasses have a dispersion ratio that remains substantially constant over the desired range of infrared wavelength; and joining the at least two infrared optical elements together.

### BRIEF DESCRIPTION OF THE DRAWINGS

The patent or application filed contains at least one drawing executed in color. Copies of this patent or patent application publication with color drawing(s) will be provided by the Office upon request and payment of the necessary fee. The invention and further details, such as features and attendant advantages, of the invention are explained in more detail below on the basis of the exemplary embodiments which are diagrammatically depicted in the drawings, and wherein:

FIG. 1 shows a P-V (partial dispersion—Abbe number) diagram for typical infrared materials in each IR band (SWIR, MWIR, LWIR) in which color of the data points indicates refractive index;

FIG. 2 is a graph (log-log scale) of absolute value of dispersion (v) [μm⁻¹], as a function of wavelength (λ) [μm] for commonly used IR range materials;

FIG. 3 is a graph of dispersion ratio as a function of wavelength for several pairs of glass elements (GaP/ZnSe, ZnSe/AgCl, ZnSe/KRS5, and ZnSe/AgCl+KRS5);

FIG. 4 is a graph (log-log scale) of minimum dispersion (v) [μm⁻¹] as a function of minimum wavelength (λₘᵢₙ) [μm] for commonly used IR range materials, wherein data point color is indicative of refractive index;

FIG. 5 is a graph (log-log scale) of minimum dispersion (v) [μm⁻¹] as a function of minimum wavelength (λₘᵢₙ) [μm] for commonly used visible optics, wherein data point color is indicative of the value.

FIG. 6 is a graph of instantaneous Abbe number as a function of wavelength (λₘᵢₙ) [μm] for selected infrared materials which possess similar minimum dispersion wavelengths.

FIG. 7 is a graph of instantaneous partial dispersion as a function of wavelength for selected IR materials which possess similar minimum dispersion wavelengths.

FIG. 8 is a plot of instantaneous Abbe number versus minimum dispersion wavelength for standard optical glasses. Potential glass selections for triplets and doublets are highlighted.

FIG. 9 is a plot of instantaneous Abbe number versus minimum dispersion wavelength for infrared optical materials. Potential material selections for triplets and doublets are highlighted.

The invention thus provides a method that facilitates the construction of multi-band IR optics by simplifying the factors to be considered regarding the relationship between refractive index and wavelength. Moreover, as this method is based on first principles for all optical materials, the method may be applied in all electromagnetic bands, although an expanded form of the Sellmeier equation, which correlates refractive index and wavelength, may be needed outside of the visible and IR regions.

The Abbe number (V) is a reciprocal measure of dispersion in the visible wavelength band and is traditionally defined using the following relation:

$${V}_{d} = \frac{{n}_{d} - 1}{{n}_{F} - {n}_{C}}$$

where n_{d} represents the index as measured using the d emission line of sodium at 587.6 nm while n_{F} and n_{C} are measured at 486.1 nm and 656.3 nm respectively. Abbe number, therefore, is the reciprocal of the change in wavelength across the majority of the visible band normalized to the value of (n−1) in the center of the band. This last quantity, hereafter expressed as μ, defines the optical power of a lens with a given curvature.

The partial dispersion (P) is defined by the following:

$${P}_{d} = \frac{{n}_{d} - {n}_{C}}{{n}_{F} - {n}_{C}} .$$

Here, P defines the portion of the total change in refractive across the band which occurs in only short wavelength part of the band. Values of P near 0.5 express that there is little change in dispersion with wavelength. In theory, P may have any value, with large values indicating a rapid decrease in dispersion with wavelength, while values below 0.5 indicate that dispersion is increasing with wavelength.

In selecting glasses for lenses with multiple elements such as doublets and triplets for the visible spectrum, the typical parameters that are considered are Abbe number, V, and partial dispersion, P. See, for example, Fischer et al., “Removing the Mystique of Glass Selection,” SPIE Proceedings, Vol. 5524, Oct. 24, 2004 (available on line at www.opticsl.com/pdfs).

As discussed in Fischer et al., for achromatic doublets the optical elements (i.e., a positively powered crown glass and a negatively powered flint glass) are selected so that the primary axial color (i.e., the focal length difference between the red and blue wavelengths at 0.6563 μm and 0.4861 μm) is zero, or as close as possible thereto. To achieve this result, the glasses are selected so that the difference in Abbe number is at least about 20.

Fischer et al. further disclose that to correct or minimize secondary color (i.e., the difference in focal lengths between the red wavelength at 0.6563 μm and the yellow wavelength at 0.5876 μm) the glass elements are selected so that their difference in partial dispersion P is as small as possible.

In designing an achromatic, apochromatic, or superachromatic lens, a number of glasses are combined such that the following relation is observed

$${\sum }_{i} \frac{{K}_{i}}{{V}_{i}} = 0$$

where K is the power in diopters of each i^{th} optical element and V is the Abbe number of its material. In order to create a focusing optic, this means at minimum combining a positive element of low dispersion with a higher dispersion negative element of lesser power. In doing so, an achromatic doublet is created which brings two wavelengths within the band to the same focal length. As discussed above, the glass elements are selected to have different Abbe numbers, for example, a difference of at least 20.

However, this leaves wavelengths near the center and at the edges of the wavelength band slightly defocused. This is the condition referred to as secondary color (see above). Secondary color occurs because the rate of change of dispersion for the two materials, or partial dispersions, is generally different. As noted above, to minimize this effect, the glasses for the elements are selected so that their partial dispersions are as similar as possible, while still maintaining a large difference in Abbe number.

Since most glasses exhibit the characteristic of constant ratio between Abbe number and partial dispersion, it was considered impossible to fully correct secondary color without the use of fluorite (CaF₂) until the first half of the 20^{th} century. It was the invention of the barium glasses and especially the lanthanum flint glasses which enabled the development of apochromatic and superachromatic triplets which are simultaneously corrected at 3 and 4 wavelengths respectively. Latter, the invention of extremely-low dispersion (ED) fluoride crown glasses enabled the replacement of fluorite elements in well-corrected doublets. This is typically accomplished by dividing the power of the elements into two. At least one of which the elements is chosen to be an anomalous dispersion glass in order to synthesize a virtual glass having similar partial dispersion, but different Abbe number than that of the other element.

In the IR range, the band of interest is not generally fixed but will vary depending on the detector type and on the transmission of the materials used for the optics. This makes Abbe number difficult to define as it varies greatly with the span of wavelengths used. The main challenge to the usefulness of the Abbe number, however, is that it is so highly variable for mute-spectral systems. FIG. 1 presents a P-V diagram for typical infrared materials in each IR band. IG5 (Ge—Sb—Se) and IG6 (As—Se) are infrared chalcogenide glasses available from Schott North America, Inc. These glasses are now called IRG25 and IRG26, respectively.

In each band there are clear combinations that could be of use, generally those forming a large triangle or pairs which share the same or very similar P, but very different V. Unfortunately, these tend to include halide materials which are soft and often very hygroscopic. Germanium is not of interest for application in the SWIR band due to its transmission, but its LWIR dispersion is unparalleled often requiring no chromatic correction to remain diffraction limited. However, for multi-band applications, its properties are so unlike other materials as to be near impossible balance within a doublet or triplet. In a general sense, it is apparent how dramatically the diagrams change between IR bands, and it becomes clear how these definitions become awkward in the infrared region.

Thus, in accordance with the invention, an alternate method for defining dispersion was determined for IR applications.

The Sellmeier equation is an empirical relationship between refractive index and wavelength and is used to determine the dispersion of light in a refracting medium. The usual form of the Sellmeier equation for glasses is:

$${n}^{2} ( λ ) = 1 + \frac{{B}_{1} {λ}^{2}}{{λ}^{2} - {C}_{1}} + \frac{{B}_{2} {λ}^{2}}{{λ}^{2} - {C}_{2}} + \frac{{B}_{3} {λ}^{2}}{{λ}^{2} - {C}_{3}}$$

where n is refractive index, λ is wavelength, and B₁, B₂, B₃, C₁, C₂, and C₃ are experimentally determined Sellmeier coefficients.

Applicant has determined that satisfactory agreement may be achieved for nearly all well-known IR materials using a modified single form of the Sellmeier equation over the wavelength range of 0.4-12 μm. This observation has important repercussions, as using a single form helps to better highlight the similarities between optical materials, which are often as important as the differences. The recommended form of the Sellmeier equation is shown below:

$${n ( λ )}^{2} - 1 = A + \frac{{B}_{1} {λ}^{2}}{{λ}^{2} - {C}_{1}} + \frac{{B}_{2} {λ}^{2}}{{λ}^{2} - {C}_{2}}$$

where A is related to the DC dielectric constant of the material, B₁ is related to short wavelength UV or visible absorption, and B₂ is related to long wavelength phonon absorption in the infrared.

Using this form, a unique solution is usually found (given a sufficiently broad dataset) and the fit residuals are still comparable to the 3-pole solution, showing that the relationship still adequately reproduces physical behavior. It can also be shown that this relation adequately reproduces the dispersion behavior of all optical glasses in the SCHOTT catalog, except for the F and SF series glasses, for which the refractive index data does not currently extend sufficiently far into the IR and the long-wavelength pole is therefore not uniquely defined.

By analogy, the Abbe number references the first derivate of index, while the partial dispersion references the second derivative. With a well-defined functional form of the index-wavelength dependence, the instantaneous derivative (v) can be directly calculated at any wavelength.

$$v ( λ ) = \frac{d n}{d λ} = {n ( λ )}^{- 1} \sum \frac{- {B}_{i} {C}_{i} λ}{{( {λ}^{2} - {C}_{i} )}^{2}}$$

The absolute value of dispersion for several commonly used IR materials is shown in FIG. 2. IRG2 (germanium oxide based) and IRG11 (calcium aluminate glass) are glasses available from Schott North America, Inc. IRG22 (Ge₃₃As₁₂Se₅₅), IRG23 (Ge₃₀As₁₃Se₃₂Te₂₅), IRG24 (Ge₁₀As₄₀Se₅₀), IRG25 (Ge₂₈Sb₁₂Se₆₀) and IRG26 (As₄₀Se₆₀) are infrared chalcogenide glasses available from Schott North America, Inc.

It is clear from the above equation and FIG. 2 that the magnitude of the dispersion decreases with the inverse cube of wavelength near the electronic bandgap (λ>C₁^{1/2}) and increases linearly for wavelengths near the multi-phonon edge (λ<C₂^{1/2}). This behavior produces a wavelength at which dispersion reaches a minimum (i.e., λₘᵢₙ) located in the infrared for most materials where:

$$\sum \frac{{B}_{i} {C}_{i} ( {C}_{i} - 3 {λ}^{2} )}{{( {λ}^{2} - {C}_{i} )}^{3}} = 0.$$

Dispersion becomes asymptotic very near the band edges and the effect of this for some high-dispersion materials, such as TiO₂ (rutile) or GaP, is that they never appear to follow a power law. It is important to note that any pair of materials where the spacing between their curves in the FIG. 2 remains nearly constant over wavelength (log-log plot), will give dispersion values which are nearly a constant ratio of each other. Under such conditions, a pair lenses can be constructed such that the sum of the products of their powers and material dispersions (eq. Y) is near zero over a wide range of wavelengths, making a good choice for an achromatic doublet. Such a choice can also been seen to present similar wavelengths for minimum dispersion (λₘᵢₙ).

In FIG. 3, the pairing of GaP and ZnSe is found to yield a near constant dispersion ratio of 2 across the SWIR and MWIR bands and is approximately 2.5 in the LWIR. Thus, a negative GaP element combined with a positive ZnSe element could give an achromatic doublet with minimal secondary color in the SWIR and MWIR bands. Referring back to the P and V diagrams in FIG. 1, this pair can be seen to share very similar P values but different V in the SWIR and MWIR ranges, and thus will make a good doublet for SWIR and MWIR bands, but the situation changes for the LWIR band, indicating GaP and ZnSe are not as well matched in this range.

In FIG. 3, ZnSe is also paired with AgCl and KRS-5 (thallium bromide/iodide). While ZnSe pairs with either material fairly well in the LWIR, it does not appear to make a satisfactory doublet in the other bands with either material. However, by moving ¼ of the positive power from AgCl to KRS-5, making a triplet, it is possible to construct a combination which works well with ZnSe across the entire 1-12 μm range. Again, this is functionally similar to the typical selection and design process used in the visible range with oxide glasses, but done in a more clear way than by using three Abbe diagrams simultaneously (see FIG. 1).

FIG. 4 is an example of an Abbe-type diagram that can be used in the design of infrared optics. As before, the dispersion minimum for each material is given on a log-log scale. An achromatic doublet may be designed by choosing two materials which have similar minimum dispersion wavelengths but with different values of the minimum dispersion. Similarly, an apochromatic triplet may be built from three materials where two materials are combined to correct the dispersion of a third which is offset vertically. It is not strictly necessary for λₘᵢₙ of the third material to be located between those of the other two, but this tends to yield better correction with lower surface curvatures, so is generally preferred. Since the same phenomena apply in the visible range with traditional oxide glasses, this range may be examined by analogy. IG2-1G6 are infrared chalcogenide glasses available from Schott North America, Inc. These glasses are now called IRG22-IRG26, respectively (see above).

A dispersion diagram for the oxide glass members of the SCHOTT glass catalog (2012), hereby incorporated by reference, are shown in FIG. 5. There are several notable features in this FIG. 5. First, the refractive index is strongly correlated to the minimum dispersion wavelength. Second, the glasses appear to fall into four distinct series. The first includes the standard silicate and lead silicate glasses which appear on the “normal” glass line. The second group includes borate crowns, barium flints and titanium (N-type) short flints. The third group includes the highly anomalous lanthanum crowns and flints. The last group contains the low-dispersion fluoride (ED) glasses. In the encircled glasses are hybrid types with chemistries between those of the above categories and members of the KZFS glass series. These chemical features are not captured in a typical P-V diagram and can be attributed to the use of a more fundamental definition of dispersion.

The Abbe number and Partial dispersion may also be calculated from the instantaneous dispersion, after J. Rayces. Here the instantaneous Abbe number (V′) is calculated as

$${V}^{′} = - \frac{1}{2} \frac{n ( λ ) - 1}{v ( λ )}$$

where v is the derivative of refractive index with wavelength. Instantaneous partial dispersion (P′) may be calculated as:

$${P}^{′} = \frac{1}{2} - \frac{1}{4} \frac{ϕ ( λ ) - 1}{v ( λ )} ,$$

where is φ the second derivative of refractive index with wavelength. The Abbe number and partial dispersion of a material across a spectroscopic band may be calculated by multiplying V′ and P′ by the width of the band.

FIG. 6 displays the instantaneous Abbe number and FIG. 7 displays the instantaneous partial dispersion of various materials as a function of wavelength. One can see from the Figures that material pairings, such as ZnS or As₂S₃ with CsBr, which display similar partial dispersions at all wavelengths, also show Abbe numbers which are a constant ratio of each other. This is seen as a constant offset on a logarithmic scale. Similar graphs show that the pairing ZnS with KBr also show similar partial dispersions at all wavelengths and Abbe numbers which are a constant ratio of each other.

In FIG. 8 is shown an Abbe-type diagram of the maximum instantaneous Abbe number, which corresponds with minimum dispersion and the wavelength at which this point occurs for the standard SCHOTT glass catalog. As with FIG. 5, this displays glasses grouped by families which are chemically similar. FIG. 9 displays an identical diagram for infrared materials. In both Figures, optimal glass selections for doublets have been identified by dashed lines, which solid triangle show optimal triplet groupings.

As before, an achromatic doublet may be designed from glasses with a large vertical separation but minimal horizontal separation. Optimally, this would include a positive element from the type-4 (FK series) glasses with a negative element of a mid- to high-index member of the type-3 glasses (LASF series). For an apochromatic triplet the positive element may be derived from either an type-4 glass or a low-index member of the type 1 glasses (K or BAK), while the negative power is split between a low-index member of the type-3 glasses (LAK or KZFS) and a high-index member of the type-2 glasses (N-SF series). It is important to note that just such glasses are commonly chosen based on recommendations from literature sources that use traditional P-V diagrams. The glasses are also selected by again choosing the set on FIG. 8 which comprises a triangle with the largest inscribed area. Thus, this method of presenting dispersion data can be seen to yield glass selections which are at least as useful as those made by the more usual means, but also give insight into the effect of glass chemistry on the refractive properties.

To provide a comparison, under the old rules for selecting lenses for use in the visible range, to make a doublet the glass elements were selected so that the two glasses had large Abbe number difference, ΔV, and a small partial dispersion difference, ΔP. For a triplet, the glasses were selected so that the deviation was as large as possible, i.e., the inscribed area of the triangle formed by the three glasses on a graph of wavelength as a function of Abbe number was as large as possible. Under the new selection criteria described herein, for IR materials the glass of a doublet are selected so that the two glasses have a large Δv or ΔV′ and small Δλ. For a triplet, two flints are selected so that they are widely separated and a crown is selected with λ between these two flints, with maximum Δv.

Another important factor is the influence of temperature on the combined focal length of an optical system. The thermal coefficient (δ) for a material, which is given by:

$$δ = \frac{β}{n - 1} - α$$

where n is the refractive index (taken at λₘᵢₙ), β is the change in refractive index with temperature (dn/dT) in ppm/K, and a is the coefficient of thermal expansion in ppm/K. Consideration of the thermal coefficient of materials is important for the design of optics which are intended to function over a broad temperature range without refocusing. This is particularly the case of IR optics because there is a much larger variation in β for typical IR materials as compared to visible glasses.

In order to create a passively athermal system, the temperature-induced change in focal length of the optics should balance the thermal expansion of the housing which sets the distance to the focal plane array. Given the relation between powers and dispersions of the lens elements in an achromatic doublet, the thermal expansion of the housing and the thermal coefficients of the lens materials needed for athermalization are related through the following:

v₁(δ₂+αₕ)=v₂(δ₁+αₕ).

where αₕ is the thermal expansion coefficient of the housing material (i.e., the housing holding the lens) and

$$δ = \frac{β}{n - 1} - α$$

(thermal change in focal power). Since the thermal expansion of most housing materials is in the range of 9-24 ppm/K, this implies that the thermal coefficient of both materials must be relatively similar and are most easily balanced at values near −αₕ.

FIG. 6 corresponds to FIG. 5, except that the data points are recolored to present the δ values (rather than refractive index), while the refractive index is correlated to feature size. It can be seen that most optical glasses display ε values within a narrow range around zero while the fluoride glasses (FK and PPK) are highly negative. This is caused by a large increase in the thermal expansion, which is related to decreasing average bond energy with fluorine incorporation. Using such glasses tends to cause problems for athermalizing the optical system as there are no candidate flint glasses with similar β values and the best overall flint glass choice for a such a system would be N-LAK37, switching the crown glass to a type-1, such as N-KF9, would create a doublet with significantly improved thermal performance, but at a lower dispersion ratio which would require stronger surface curvatures at the same focal length.

FIG. 7 corresponds to FIG. 4, except that the data points are recolored to present the β values. The reason for CaF₂ is so prized for visible designs becomes apparent, as it is very low in dispersion compared to the oxide glasses, but it's minimum dispersion wavelength is centered in the same region. When combining data for both visible and IR materials, the relative scarcity of choices to work with in the IR region and the much greater variability in their properties become apparent. The main value of the chalcogenide glasses (IG materials) as compared to the crystalline semiconductors is their low dispersion and thermal coefficients which are much closer to −α for most metals. IG4 for instance is athermal with respect to titanium and some steels, while IGX-C is athermal with respect to aluminum. While halide salts and germanium have excellent dispersion values, their thermal behavior can severely limit performance with varying temperature. The above β values are all expressed at a single wavelength; however, it is important to note that the value of β also displays dispersive behavior, correlating to a change in the dispersion with temperature.

### EXAMPLES

### Example 1

An achromatic doublet is prepared from a first glass element made from the glass IGX-A (K=−0.923, made by Schott Glass) and a second glass element made from the glass IGX-C (K=+2.414, made by Schott Glass). The resultant optical lens is achromatic in the wavelength ranges of 0.7 μm 1.8 μm, and 8-12 μm, and is passively athermal when mounted in a housing of CTE=29 ppm/K This value is close enough to that of aluminum (23 ppm/K) as to allow good thermal performance near room temperature with an aluminum housing. A diffractive element is used to correct for LWIR dispersion, and the refractive powers are optimized for best shortwave performance.

### Example 2

An achromatic doublet is prepared from a first glass element made from the glass IGX-B (K=−1.130, made by Schott Glass) and a second glass element made from an AgCl crystal (+2.274)). The resultant optical lens is achromatic in the wavelength ranges of 0.7 μm 1.8 μm, and 8-12 μm, and is passively athermal when mounted in a housing of CTE=227 ppm/K. This value is large enough to require active re-focusing or heating of the lens assembly even over a very narrow range of ambient temperatures. A diffractive element is used to correct for LWIR dispersion, and the refractive powers are optimized for best shortwave performance.

### Example 3

An apochromatic triplet is prepared from a first glass element made from the glass IGX-A (K=−0.817, made by Schott Glass), a second glass element made from the glass IGX-B (K=+3.434, made by Schott Glass), and a third glass element made from the glass IGX-C (K=−0.920, made by Schott Glass). The resultant optical lens is apochromatic within the wavelength range of 0.7-12 μm and is passively athermal when mounted in a housing of CTE=66 ppm/K. No diffractive element is need, but one may be used to enhance thermal or chromatic correction.

### Example 4

An apochromatic triplet is prepared from a first glass element made from the glass IGX-A (K=−0.817, made by Schott Glass), a second glass element made from the glass AgCl (K=+3.434), and a third glass element made from the glass ZnS (K=−0.920, made by Schott Glass). The resultant optical lens is apochromatic within the wavelength range of 0.67-12 μm and is passively athermal when mounted in a housing of CTE=208 ppm/K. No diffractive element is need, but one may be used enhance thermal or chromatic correction.

### Example 5

An apochromatic triplet is prepared from a first glass element made from the glass IG6 (K=−2.707, made by Schott Glass), a second glass element made from the glass IG4 (K=+3.611, made by Schott Glass). The resultant optical lens is apochromatic within the wavelength range of 1.0-12 μm and is passively athermal when mounted in a housing of CTE=34.6 ppm/K. A diffractive element is used to correct the LWIR region, and refractive powers are optimized for correction in the SWIR range.

### Example 6

An apochromatic triplet is prepared from a first glass element made from the glass IG6 (K=−2.707, made by Schott Glass), a second glass element made from the glass IG4 (K=+3.611, made by Schott Glass). The resultant optical lens is apochromatic within the wavelength range of 1.0-12 μm, and is passively athermal when mounted in a housing of CTE=34.6 ppm/K. A diffractive element is used to correct the LWIR region, and refractive powers are optimized for correction in the SWIR range.

The entire disclosure[s] of all applications, patents and publications, cited herein, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. A method of manufacturing an infrared optical lens comprising a plurality of infrared optical elements, said method comprising:
selecting glasses for at least two of said infrared optical elements such that the glasses have similar minimum dispersion wavelengths but differing values of minimum dispersion; and
joining said at least two of said infrared optical elements together.

2. A method according to claim 1, wherein said infrared optical lens is in the form of a doublet.

3. A method according to claim 1, wherein said infrared optical lens is in the form of a triplet.

4. A method according to claim 1, wherein said infrared optical lens transmits infrared radiation in a wavelength spectrum that extends into the SWIR and MWIR ranges.

5. A method according to claim 1, wherein said infrared optical lens transmits infrared radiation in a wavelength spectrum that extends into the MWIR and LWIR ranges.

6. A method according to claim 1, wherein said infrared optical lens transmits infrared radiation in a wavelength spectrum that extends into the SWIR, MWIR and LWIR ranges.

7. A method of manufacturing an infrared optical lens comprising a plurality of infrared optical elements, said method comprising:
selecting glasses for at least two of said infrared optical elements such that the glasses have a dispersion ratio that remains substantially constant over the desired range of infrared wavelength; and
joining said at least two of said infrared optical elements together.

8. A method according to claim 7, wherein said infrared optical lens is in the form of a doublet.

9. A method according to claim 7, wherein said infrared optical lens is in the form of a triplet.

10. A method according to claim 7, wherein the desired range of infrared wavelength extends into the SWIR and MWIR ranges.

11. A method according to claim 7, wherein the desired range of infrared wavelength extends into MWIR and LWIR ranges.

12. A method according to claim 7, wherein the desired range of infrared wavelength extends into SMIR, MWIR and LWIR ranges.

13. A method according to claim 7, wherein dispersion ratio differs by less than 0.30 over the desired range of infrared wavelength.

14. A method according to claim 7, wherein dispersion ratio differs by less than 0.25 over the desired range of infrared wavelength.

15. A method according to claim 7, wherein dispersion ratio differs by less than 0.20 over the desired range of infrared wavelength.

16. A method according to claim 7, wherein dispersion ratio differs by less than 0.10 over the desired range of infrared wavelength.

17. A method according to claim 7, wherein dispersion ratio differs by less than 0.05 over the desired range of infrared wavelength.
